(19) United States
(12) Patent Application Publication
(10) Pub. No.: US 2026/0235039 A1
(43) Pub. Date: Aug. 13, 2026

(54) TURBINE STATOR VANE AND GAS TURBINE

(71) Applicants: MITSUBISHI HEAVY INDUSTRIES, LTD., Tokyo (JP); MITSUBISHI POWER, LTD., Tokyo (JP)

(72) Inventors: Masayoshi HATTA, Tokyo (JP); Keiya ISHIYAMA, Tokyo (JP); Kazuki MORIMOTO, Tokyo (JP); Susumu WAKAZONO, Tokyo (JP); Takuya IZUMI, Tokyo (JP); Shinya HASHIMOTO, Tokyo (JP); Koji WATANABE, Tokyo (JP)

(21) Appl. No.: 19/155,429

(22) PCT Filed: Feb. 21, 2024
(86) PCT No.: PCT/JP2024/006199

§ 371 Date: Aug. 11, 2025

(30) Foreign Application Priority Data
Mar. 2, 2023 (JP) 2023-031598

(51) Int. Cl. F01D 9/04

(52) U.S. Cl. CPC F01D 9/041; F05D 2220/32; F05D 2240/12

(57) ABSTRACT

A turbine stator vane includes: a vane-shaped part; an inner shroud; a pair of circumferential wall parts that, at ends on one side and the other side in the circumferential direction in the inner shroud, extend in the extending direction of the ends; a longitudinal wall part which extends in the circumferential direction, in which ends on one side and the other side in the circumferential direction are connected to the pair of circumferential wall parts, and which projects from the inner shroud; a connection part that connects, through a gentle curved surface, the longitudinal wall part and the pair of circumferential wall parts; and a first plate member that constitutes a cavity together with a surface on the opposite side of the inner shroud and the pair of circumferential wall parts. The first plate member has a first planar part, a second planar part, and a curved surface part.

### TECHNICAL FIELD

The present disclosure relates to a turbine stator vane and a gas turbine.

The present application claims the benefit of priority based on Japanese Patent Application No. 2023-031598 filed to the Japanese Patent Office on Mar. 2, 2023, the content of which is incorporated herein by reference.

### BACKGROUND ART

A gas turbine includes a compressor that compresses atmospheric air to generate compressed air, a combustor that combusts fuel in the compressed air to generate a combustion gas, and a turbine that is driven by the combustion gas. The turbine includes a turbine rotor that rotates around an axis, a plurality of stator vane stages arranged in an axial direction in which the axis extends, and a turbine casing that rotatably covers the turbine rotor. The turbine rotor includes a rotor shaft that is centered on the axis and that extends in the axial direction and a plurality of rotor blade stages fixed to the rotor shaft. Each of the plurality of rotor blade stages includes a plurality of rotor blades arranged in a circumferential direction around the axis. Any one of the plurality of stator vane stages is disposed upstream of the plurality of rotor blade stages. Each of the plurality of stator vane stages includes a plurality of stator vanes arranged in the circumferential direction around the axis.

As a stator vane, for example, there is a stator vane as described in PTL 1 as follows. The stator vane includes a stator vane body that extends in a radial direction with respect to an axis, an outer shroud that is formed outside the stator vane body in the radial direction, and an inner shroud that is formed inside the stator vane body in the radial direction.

On the inner shroud, a pair of side circumferential walls facing each other in a circumferential direction, an upstream circumferential wall provided on an upstream side in an axial direction of the turbine rotor, and a retainer facing the upstream circumferential wall in the axial direction are provided to protrude from the inner shroud toward an inner side in the radial direction of the stator vane body. A recessed portion is formed at the inner shroud by the pair of side circumferential walls, the upstream circumferential wall, and the retainer.

### CITATION LIST

### Patent Literature

[PTL 1] Japanese Unexamined Patent Application Publication No. 2016-011649

### SUMMARY OF INVENTION

### Technical Problem

A plate member may be provided to cover and close the above-described recessed portion of the inner shroud. In a case where the plate member is connected to the pair of side circumferential walls or the retainer through welding in such a case, the plate member is also connected to, through welding, a connecting portion that is smoothly connected from the pair of side circumferential walls to the retainer with a curved surface.

However, when the retainer is deformed due to heat from a combustion gas, stress in the vicinity of a portion of the plate member that is connected to the connecting portion becomes relatively high. Therefore, such a portion may be damaged due to low-cycle fatigue.

In view of the above-described circumstances, an object of at least one embodiment of the present disclosure is to improve the durability of a turbine stator vane.

### Solution to Problem

(1) According to at least one embodiment of the present disclosure, there is provided a turbine stator vane including
an airfoil portion,
an inner shroud that is provided inside the airfoil portion in a vane height direction,
a pair of circumferential wall portions that extends, at end portions of the inner shroud on one side and the other side in a circumferential direction, along a direction in which the end portions extend and that protrudes from the inner shroud toward an opposite side to the airfoil portion in the vane height direction,
a longitudinal wall portion that extends in the circumferential direction such that end portions on the one side and the other side in the circumferential direction are connected to the pair of circumferential wall portions, that protrudes from the inner shroud toward the opposite side to the airfoil portion in the vane height direction, and that protrudes to be closer to the opposite side in the vane height direction than the pair of circumferential wall portions is,
a connecting portion that connects the pair of circumferential wall portions and the longitudinal wall portion to each other via a gently curved surface, and
a first plate member that forms a cavity together with a surface of the inner shroud on the opposite side and the pair of circumferential wall portions,
in which the first plate member includes a first planar portion extending along the pair of circumferential wall portions, a second planar portion extending along the longitudinal wall portion, and a curved surface portion extending along the connecting portion, and
the curved surface portion includes thick portions of which a thickness is larger than thicknesses of the first planar portion and the second planar portion, the thick portions being provided at at least end portions on the one side and the other side in the circumferential direction.

(2) According to at least one embodiment of the present disclosure, there is provided a gas turbine including
the turbine stator vane having a configuration of (1) described above.

### Advantageous Effects of Invention

According to at least one embodiment of the present disclosure, it is possible to improve the durability of a turbine stator vane.

### BRIEF DESCRIPTION OF DRAWINGS

FIG. 1 is a schematic view showing an entire configuration of a gas turbine.

FIG. 2 is a cross-sectional view showing a gas flow path of the turbine.

FIG. 3 is a schematic front view showing a stator vane according to an embodiment.

FIG. 4 is a schematic perspective view of an inner shroud and shows a state before attachment of a first plate member and a second plate member.

FIG. 5 is a schematic perspective view of the inner shroud and shows a state after attachment of the first plate member and before attachment of the second plate member.

FIG. 6 is a cross-sectional view as seen along arrows VI-VI in FIG. 5.

FIG. 7 is a schematic perspective view of the inner shroud and shows a state after attachment of the second plate member.

FIG. 8 is an enlarged view of a main part of FIG. 7.

FIG. 9 is a cross-sectional view as seen along arrows IX-IX in FIG. 7.

FIG. 10 is a view for description of a welded portion between the first plate member and the inner shroud.

### DESCRIPTION OF EMBODIMENTS

Hereinafter, several embodiments of the present disclosure will be described with reference to the accompanying drawings. Dimensions, materials, shapes, relative arrangements, and the like of components described as embodiments or shown in the drawings are not intended to limit the scope of the present disclosure, but are merely explanatory examples.

For example, an expression representing a relative or absolute arrangement such as “in a certain direction”, “along a certain direction”, “parallel”, “orthogonal”, “center”, “concentric”, or “coaxial” does not strictly represent only such an arrangement, but also a tolerance or a state of being relatively displaced with an angle or a distance to the extent that the same function can be obtained.

For example, expressions such as “identical”, “equal”, and “homogeneous” indicating that things are in an equal state do not strictly represent only the equal state, but also a tolerance or a state where there is a difference to the extent that the same function can be obtained.

For example, an expression representing a shape such as a quadrangular shape or a cylindrical shape does not represent only a shape such as a quadrangular shape or a cylindrical shape in a geometrically strict sense, but also a shape including an uneven portion, a chamfered portion, and the like within a range in which the same effect can be obtained.

Meanwhile, the expressions “being provided with”, “comprising”, “including”, or “having” one component are not exclusive expressions excluding the presence of other components.

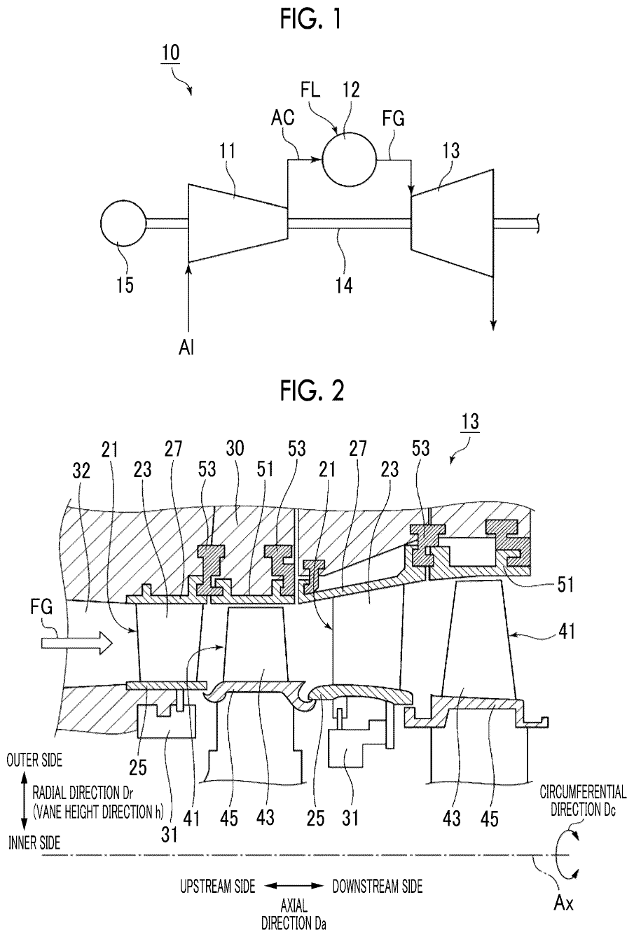

FIG. 1 is a schematic view showing an overall configuration of a gas turbine and FIG. 2 is a cross-sectional view showing a gas flow path of the turbine.

In the present embodiment, as shown in FIG. 1, a gas turbine 10 is configured such that a compressor 11, a combustor 12, and a turbine 13 are disposed to be coaxial with each other by means of a rotor 14, and a generator 15 is connected to one end portion of the rotor 14. Note that, in the following description, a direction in which an axis of the rotor 14 extends will be referred to as an axial direction Da, a circumferential direction around the axis of the rotor 14 will be referred to as a circumferential direction Dc, and a direction perpendicular to an axis Ax of the rotor 14 will be referred to as a radial direction Dr, as shown in FIG. 2. Note that the radial direction Dr will be referred to as a vane height direction h.

In the compressor 11, air AI taken in through an air intake port passes through a plurality of stator vanes and rotor blades and is compressed so that high-temperature and high-pressure compressed air AC is generated. The combustor 12 supplies a predetermined fuel FL to the compressed air AC and combusts the compressed air AC to generate a high-temperature and high-pressure combustion gas FG. In the turbine 13, the high-temperature and high-pressure combustion gas FG, which is a working fluid and is generated in the combustor 12, passes through a plurality of stator vanes and rotor blades to rotationally drive the rotor 14 and to drive the generator 15 connected to the rotor 14.

In addition, as shown in FIG. 2, in the turbine 13, turbine stator vanes (stator vanes) 21 are configured such that hub sides (an inner side in the radial direction Dr) of stator vane bodies (airfoil portions) 23 are fixed to inner shrouds 25 and tip sides (an outer side in the radial direction Dr) of the stator vane bodies 23 are fixed to outer shrouds 27. Turbine rotor blades (rotor blades) 41 are configured such that base end portions of airfoil portions 43 are fixed to platforms 45. In addition, the outer shrouds 27 and ring segments 51 which are disposed close to tip portions of the rotor blades 41 are supported by a casing (a turbine casing) 30 via thermal insulation rings 53, and the inner shrouds 25 are supported by support rings 31. Therefore, a combustion gas passage 32 through which the combustion gas FG passes is formed along the axial direction Da as a space surrounded by the inner shrouds 25, the outer shrouds 27, the platforms 45, and the ring segments 51.

Note that the inner shrouds 25 and the outer shrouds 27 function as gas path surface forming members. A gas path surface forming member is a member that defines the combustion gas passage 32 and that includes a gas path surface brought into contact with the combustion gas FG.

The configuration of the stator vanes 21 according to an embodiment, particularly the inner shrouds 25 and each part of the inner shrouds 25 on the inner side in the radial direction Dr will be described.

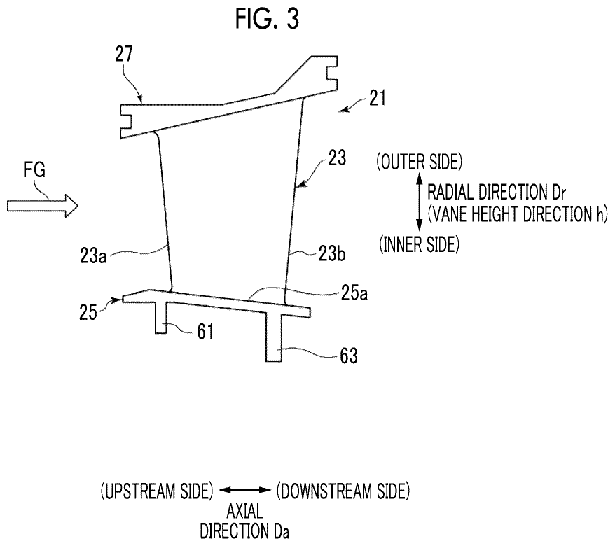

FIG. 3 is a schematic front view showing a stator vane according to an embodiment.

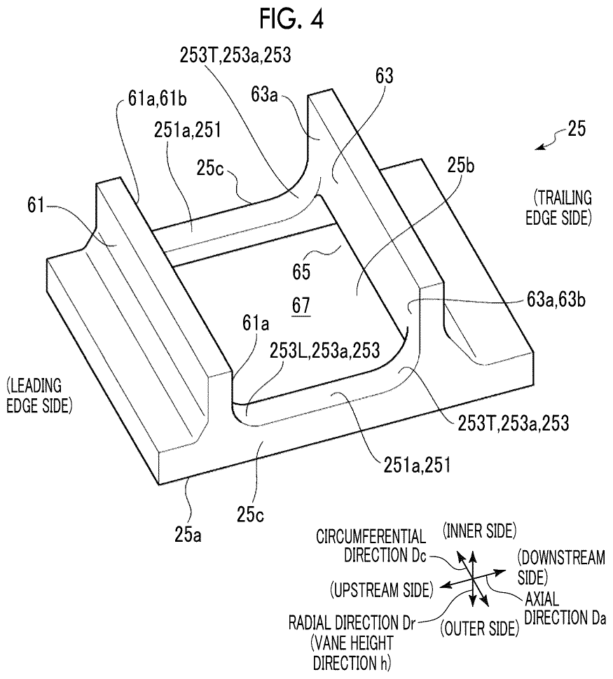

FIG. 4 is a schematic perspective view of an inner shroud and shows a state before attachment of a first plate member and a second plate member, which will be described later.

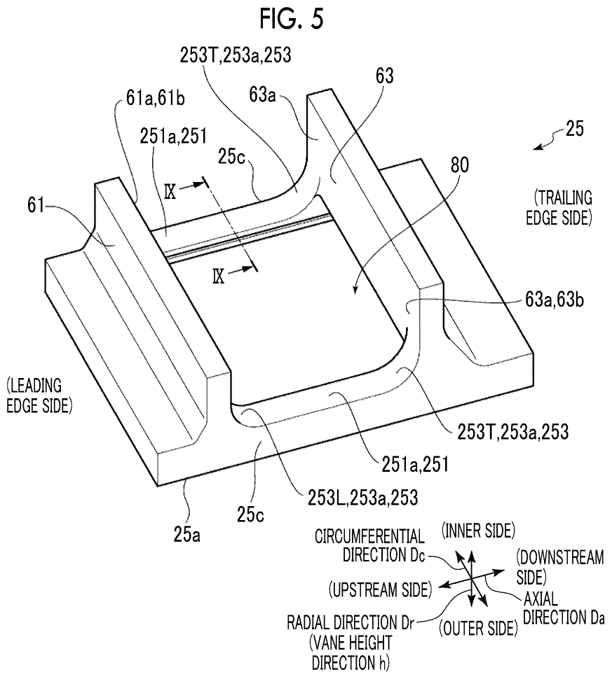

FIG. 5 is a schematic perspective view of the inner shroud and shows a state after attachment of the first plate member to be described later and before attachment of the second plate member to be described later.

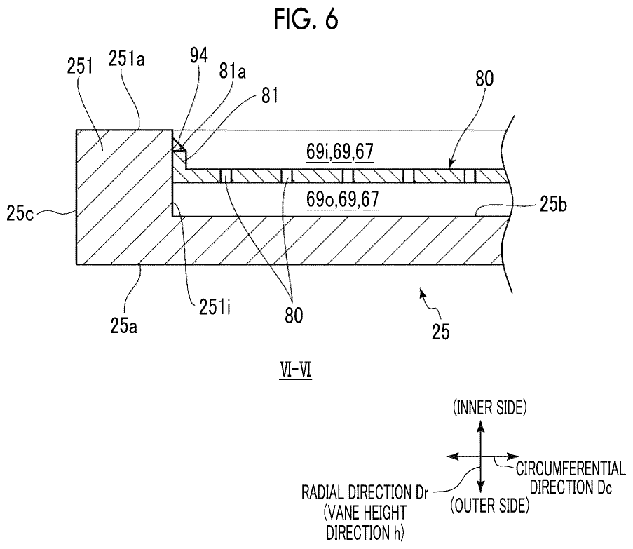

FIG. 6 is a cross-sectional view as seen along arrows VI-VI in FIG. 5.

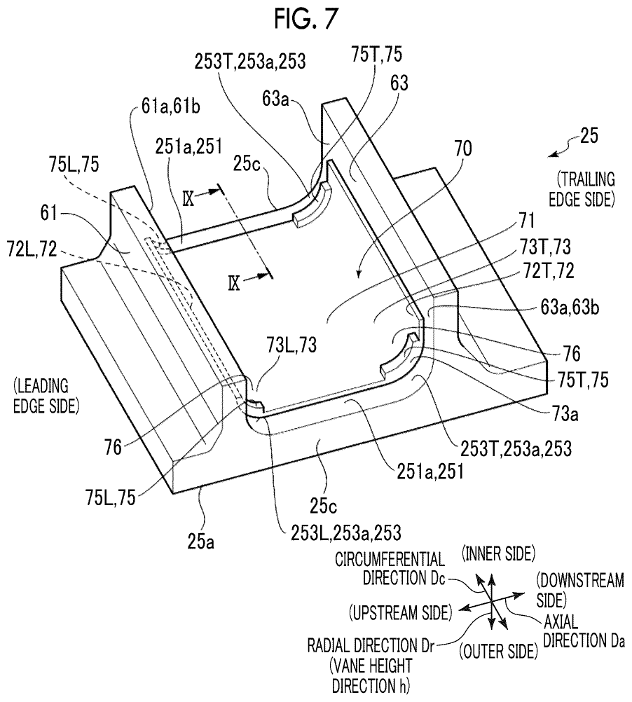

FIG. 7 is a schematic perspective view of the inner shroud and shows a state after attachment of the second plate member to be described later.

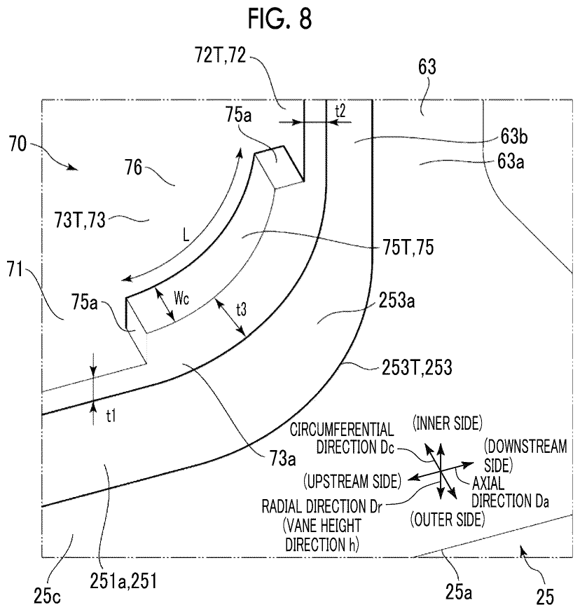

FIG. 8 is an enlarged view of a main part of FIG. 7.

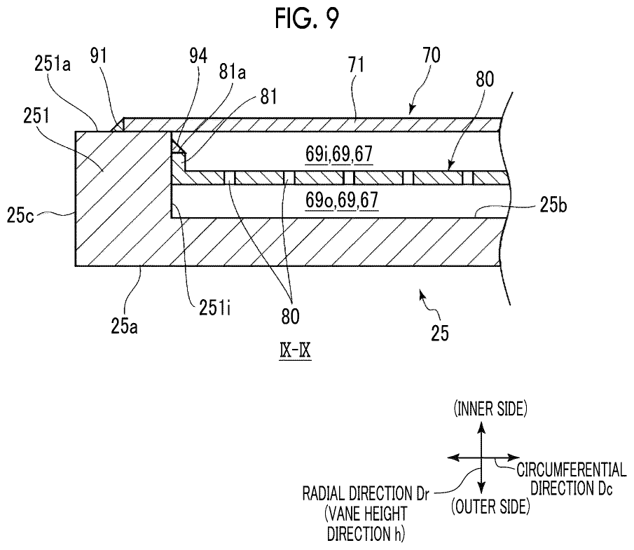

FIG. 9 is a cross-sectional view as seen along arrows IX-IX of FIG. 7.

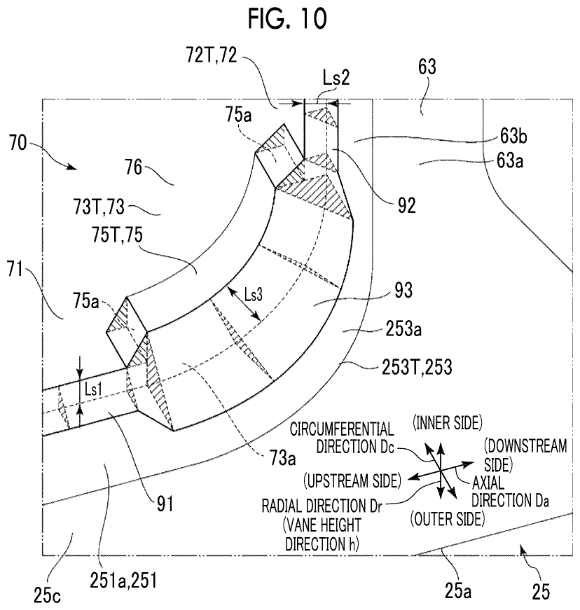

FIG. 10 is a view for description of a welded portion between the first plate member and the inner shroud.

As shown in FIG. 3, in the case of the stator vane 21 according to the embodiment, the hub side of the airfoil portion 23, that is, one end portion in the vane height direction (an end portion on the inner side in the radial direction Dr) is provided with the inner shroud 25 and the tip side, that is, the other end portion in the vane height direction (an end portion on the outer side in the radial direction Dr) is provided with the outer shroud 27.

### Circumferential Wall Portions 251, Leading Edge Side Retainer 61, and Trailing Edge Side Retainer 63

As shown in FIG. 4, the stator vane 21 according to the embodiment is provided with a pair of circumferential wall portions 251 that extends, at end portions 25c of the inner shroud 25 on one side and the other side in the circumferential direction Dc, along a direction in which the end portions 25c extend and that protrudes from the inner shroud 25 toward an opposite side (the inner side in the radial direction Dr) to the airfoil portion 23 in the vane height direction h.

The stator vane 21 according to the embodiment includes a leading edge side retainer 61 and a trailing edge side retainer 63 that extend toward the inner side in the radial direction Dr, which is an opposite side to the airfoil portion 23, with a gas path surface 25a interposed therebetween. The leading edge side retainer 61 is formed on a leading edge 23a side of the airfoil portion 23, and the trailing edge side retainer 63 is formed on a trailing edge 23b side of the airfoil portion 23. The leading edge side retainer 61 and the trailing edge side retainer 63 are attached to the casing 30 via the support ring 31 (refer to FIG. 2).

The leading edge side retainer 61 and the trailing edge side retainer 63 are longitudinal wall portions that extend in the circumferential direction Dc such that end portions 61a and 63a on the one side and the other side in the circumferential direction Dc are connected to the pair of circumferential wall portions 251, that protrude from the inner shroud 25 toward an opposite side (the inner side in the radial direction Dr) to the airfoil portion 23 in the vane height direction h, and that protrude to be closer to the opposite side (the inner side in the radial direction Dr) in the vane height direction h than the pair of circumferential wall portions 251 is.

An opening 65 penetrating the trailing edge side retainer 63 in the axial direction Da is formed in the trailing edge side retainer 63.

### Connecting Portion 253

In addition, the stator vane 21 according to the embodiment includes connecting portions 253 that connect the pair of circumferential wall portions 251, the leading edge side retainer 61, and the trailing edge side retainer 63 to each other via gently curved surfaces 253a, the leading edge side retainer 61 and the trailing edge side retainer 63 being the longitudinal wall portions. The curved surfaces 235a connect end surfaces 251a of the pair of circumferential wall portions 251 that face the inner side in the radial direction Dr and surfaces 61b and 63b of the leading edge side retainer 61 and the trailing edge side retainer 63, to each other.

The connecting portions 253 include leading edge side connecting portions 253L that connect the pair of circumferential wall portions 251 and the leading edge side retainer 61 to each other, and trailing edge side connecting portions 253T that connect the pair of circumferential wall portions 251 and the trailing edge side retainer 63 to each other.

### Recessed Portion 67

In the case of the stator vane 21 according to the embodiment, a recessed portion 67 is formed by a surface 25b of the inner shroud 25, the pair of circumferential wall portions 251, and the leading edge side retainer 61, the surface 25b being on an opposite side to the gas path surface 25a.

### First Plate Member 70

For example, as shown in FIG. 7, the stator vane 21 according to the embodiment includes a first plate member 70 disposed to cover the recessed portion 67. The first plate member 70 forms, together with the surface 25b of the inner shroud 25 that is on the opposite side to the gas path surface 25a, the pair of circumferential wall portions 251, and the leading edge side retainer 61, a cavity 69 surrounded by the surface 25b, the pair of circumferential wall portions 251, and the leading edge side retainer 61 (refer to FIG. 9).

The first plate member 70 includes a first planar portion 71 extending along the pair of circumferential wall portions 251, second planar portions 72 extending along the leading edge side retainer 61 and the trailing edge side retainer 63 serving as the longitudinal wall portions, and curved surface portions 73 extending along the connecting portions 253.

The second planar portions 72 include a leading edge side second planar portion 72L extending along the leading edge side retainer 61 and a trailing edge side second planar portion 72T extending along the trailing edge side retainer 63.

The curved surface portions 73 include a leading edge side curved surface portion 73L extending along the leading edge side connecting portions 253L and a trailing edge side curved surface portion 73T extending along the trailing edge side connecting portions 253T.

Although not shown in FIGS. 7 and 8, end surfaces of the first plate member 70 are connected to the pair of circumferential wall portions 251, the leading edge side retainer 61, the trailing edge side retainer 63, and the connecting portions 253 through welding over the entire circumference.

Therefore, in a case where the strength of the vicinities of end portions 73a of the curved surface portions 73 on the one side and the other side in the circumferential direction Dc is not sufficient, a relatively large stress may be generated in the vicinities of the end portions 73a when the leading edge side retainer 61 and the trailing edge side retainer 63 are deformed due to heat from the combustion gas FG, which may cause damage attributable to low-cycle fatigue in the vicinities of the end portions 73a.

### Thick Portions 75

Therefore, in the case of the stator vane 21 according to the embodiment, as shown in FIGS. 7 and 8, the curved surface portions 73 are formed to include thick portions 75 of which a thickness t3 is larger than thicknesses t1 and t2 of the first planar portion 71 and the second planar portions 72, the thick portions 75 being provided at at least the end portions 73a on the one side and the other side in the circumferential direction Dc.

In the case of the stator vane 21 according to the embodiment, the thick portions 75 include leading edge side thick portions 75L formed at the end portions 73a of the leading edge side curved surface portion 73L on the one side and the other side, and trailing edge side thick portions 75T formed at the end portions 73a of the trailing edge side curved surface portion 73T on the one side and the other side.

Accordingly, the strength of the end portions 73a of the curved surface portions 73 on the one side and the other side can be improved and thus even in a case where the leading edge side retainer 61 or the trailing edge side retainer 63 is deformed due to heat from the combustion gas FG, stress in the vicinities of the end portions 73a of the curved surface portions 73 on the one side and the other side can be suppressed. Accordingly, the low-cycle fatigue strength of the vicinities of the end portions 73a of the curved surface portions 73 on the one side and the other side is improved, and the durability of the stator vane 21 is improved.

In addition, according to the gas turbine 10 of the embodiment, the durability of the turbine stator vane 21 is improved and thus the reliability of the gas turbine 10 is improved.

Regarding the stator vane 21 according to one embodiment, the thick portions 75 may be provided throughout regions extending from the end portions 73a of the curved surface portions 73 on the one side to the end portions 73a on the other side, or may be provided only in the vicinities of the end portions 73a of the curved surface portions 73 on the one side and the end portions 73a on the other side, as shown in FIGS. 7 and 8. That is, the curved surface portion 73 may include a non-thick portion 76 that is positioned between the thick portions 75 at the end portions 73a on the one side and the other side in the circumferential direction Dc and of which the thickness is smaller than the thickness t3 of the thick portions 75.

Accordingly, the vicinities of the end portions 73a of the curved surface portions 73 on the one side and the other side, of which the strength needs to be improved, can be efficiently reinforced.

Note that in a case where the thicknesses t1 and t2 of the first planar portion 71 and the second planar portions 72 are equal to each other and the thickness of the non-thick portion 76 is equal to the thicknesses t1 and t2 of the first planar portion 71 and the second planar portions 72, the first plate member 70 can be formed by bending a single plate member and thus the cost of the first plate member 70 can be suppressed.

In the case of the stator vane 21 according to the embodiment, for example, the thick portions 75 may be provided to have a prescribed width Wc in the circumferential direction Dc with the end portions 73a of the curved surface portions 73 on the one side and the end portions 73a on the other side as origins. The width Wc of the thick portions 75 may be equal to or larger than 2.5 times the thickness t1 of the first planar portion 71, for example.

In addition, in the case of the stator vane 21 according to the embodiment, the thick portion 75 extends along the axial direction Da and the radial direction Dr. However, an extension length L (refer to FIG. 8) thereof may be a length that reaches from the first planar portion 71 to the second planar portion 72, and may be a length that results in at least one of two end portions 75a being positioned within the curved surface portion 73.

### Regarding Connection of First Plate Member 70 Through Welding

As described above, the end surfaces of the first plate member 70 are connected to the pair of circumferential wall portions 251, the leading edge side retainer 61, the trailing edge side retainer 63, and the connecting portions 253 through welding over the entire circumference.

Regarding the first plate member 70, as shown in FIG. 10, the end portions 73a of the curved surface portion 73 on the one side and the other side in the circumferential direction are welded to the curved surfaces 253a of the connecting portions 253.

That is, the first plate member 70 is welded and fixed to the curved surfaces 253a of the connecting portions 253 in the vicinities of the thick portions 75.

Note that in FIG. 10, the respective cross-sectional shapes of welded portions 91, 92, and 93, which will be described later, are represented by hatching. In addition, in FIG. 10, for convenience of illustration, the shapes of the welded portions 91, 92, and 93 suddenly change at the boundary portions between the welded portions 91, 92, and 93. However, in practice, the welded portions 91, 92, and 93 are smoothly connected to each other at the boundary portions between the welded portions 91, 92, and 93.

Regarding the first plate member 70, the first planar portion 71 is welded to the end surfaces 251a of the pair of circumferential wall portions 251, and the second planar portions 72 are welded to the surfaces 61b and 63b of the leading edge side retainer 61 and the trailing edge side retainer 63. A weld leg length Ls3 of the welded portions 93 between the end portions 73a of the curved surface portion 73 on the one side and the other side in the circumferential direction Dc and the curved surfaces 253a of the connecting portions 253 may be larger than a weld leg length Ls1 of the welded portions 91 between the first planar portion 71 and the end surfaces 251a of the pair of circumferential wall portions 251 and a weld leg length Ls2 of the welded portions 92 between the second planar portions 72 and the surfaces 61b and 63b of the leading edge side retainer 61 and the trailing edge side retainer 63.

In this case, stress can be suppressed at the welded portions 93 between the end portions 73a of the curved surface portions 73 on the one side and the other side in the circumferential direction Dc and the curved surfaces 253a of the connecting portions 253, at which stress is likely to become relatively large due to deformation of the leading edge side retainer 61 or the trailing edge side retainer 63 caused by heat from the combustion gas FG.

Note that the thick portions 75 may be formed on surfaces of plate portions constituting the curved surface portions 73 through padding although the thick portions 75 may be formed by welding arc-shaped members to the curved surface portions 73.

In this case, the vicinities of the end portions 73a of the curved surface portions 73 on the one side and the other side, of which the strength needs to be improved, can be reinforced relatively easily.

### Second Plate Member 80

The stator vane 21 according to the embodiment includes a second plate member 80 that partitions the cavity 69 into a region 69o on an outer side in the vane height direction h and a region 69i on an inner side in the vane height direction h.

The second plate member 80 is a porous plate extending in the circumferential direction Dc and the axial direction Da, and includes a plurality of through-holes 80a extending in a plate thickness direction (the radial direction Dr) of the second plate member 80.

Although not shown in the drawings, the stator vane 21 according to the embodiment is configured such that cooling air is supplied from the outside to the region 69i on the inner side. The cooling air supplied from the outside to the region 69i on the inner side is discharged toward the surface 25b of the inner shroud 25, which is on the opposite side to the gas path surface 25a, through the plurality of through-holes 80a so that the surface 25b is subjected to impingement cooling.

According to the stator vane 21 of the embodiment, the cavity 69 can be partitioned into the region 69o on the outer side in the vane height direction and the region 69i on the inner side in the vane height direction h by the second plate member 80. In addition, with cooling air supplied from the outside to the region 69i on the inner side, the surface 25b of the inner shroud 25, which is on the opposite side to the gas path surface 25a, can be subjected to impingement cooling.

Regarding the second plate member 80, end portions 81 in the circumferential direction Dc are folded toward the inner side in the radial direction Dr, and end surfaces 81a facing the inner side in the radial direction Dr are connected to, through fillet welding, inner surfaces 251i facing the cavity 69 at the pair of circumferential wall portions 251. That is, the second plate member 80 is welded to the inner surfaces 251i of the pair of circumferential wall portions 251 that face each other in the circumferential direction Dc.

Welded portions 94 between the second plate member 80 and the pair of circumferential wall portions 251 are positioned closer to the outer side in the radial direction Dr than the end surfaces 251a of the pair of circumferential wall portions 251 on the inner side in the radial direction Dr are.

Note that as described above, the first planar portion 71 of the first plate member 70 is connected to the end surfaces 251a of the pair of circumferential wall portions 251 via the welded portions 91 (refer to FIGS. 9 and 10).

For example, a case where the first plate member 70 and the second plate member 80 are disposed to be stacked on the end surfaces 251a of the pair of circumferential wall portions 251 and end portions of the first plate member 70 and the second plate member 80 in the circumferential direction Dc are welded to the end surfaces 251a through fillet welding will be considered. In this case, the amount of molten metal at welded portions increases because there is an increase in height in the vane height direction h, in comparison with a case where only end portions of the first plate member 70 in the circumferential direction Dc are welded to the end surfaces 251a through fillet welding, to a degree corresponding to the plate thickness of the second plate member 80. Therefore, welding distortion is likely to occur.

According to the stator vane 21 of the embodiment, the amount of molten metal at the welded portions 91 at the time of fillet welding of the first plate member 70 and the end surfaces 251a can be reduced and thus welding distortion of the welded portions 91 can be suppressed.

The present disclosure is not limited to the above-described embodiments, and includes modifications of the above-described embodiments and a combination of these embodiments as appropriate.

For example, in the case of the stator vane 21 according to the above-described embodiment, the leading edge side thick portion 75L and the trailing edge side thick portion 75T are provided. However, a configuration in which only one of the leading edge side thick portion 75L and the trailing edge side thick portion 75T is provided may also be adopted.

For example, the contents described in each embodiment are understood as follows.

(1) The turbine stator vane 21 according to at least one embodiment of the present disclosure includes the airfoil portion 23, the inner shroud 25 that is provided inside the airfoil portion 23 in the vane height direction h, the pair of circumferential wall portions 251 that extends, at the end portions 25c of the inner shroud 25 on one side and the other side in the circumferential direction Dc, along a direction in which the end portions 25c extend and that protrudes from the inner shroud 25 toward an opposite side (the inner side in the radial direction Dr) to the airfoil portion 23 in the vane height direction h, the longitudinal wall portion (the leading edge side retainer 61 and the trailing edge side retainer 63) that extends in the circumferential direction Dc such that the end portions 61a and 63a on the one side and the other side in the circumferential direction Dc are connected to the pair of circumferential wall portions 251, that protrudes from the inner shroud 25 toward the opposite side (the inner side in the radial direction Dr) to the airfoil portion 23 in the vane height direction h, and that protrudes to be closer to the opposite side (the inner side in the radial direction Dr) in the vane height direction h than the pair of circumferential wall portions 251 is, the connecting portion 253 that connects the pair of circumferential wall portions 251 and the longitudinal wall portion (the leading edge side retainer 61 and the trailing edge side retainer 63) to each other via the gently curved surface 253a, and the first plate member 70 that forms the cavity 69 together with the surface 25b of the inner shroud 25 on the opposite side and the pair of circumferential wall portions 251. The first plate member 70 includes the first planar portion 71 extending along the pair of circumferential wall portions 251, the second planar portion 72 extending along the longitudinal wall portion (the leading edge side retainer 61 and the trailing edge side retainer 63), and the curved surface portion 73 extending along the connecting portion 253. The curved surface portion 73 includes the thick portions 75 of which the thickness is larger than the thicknesses t1 and t2 of the first planar portion 71 and the second planar portion 72, the thick portions 75 being provided at at least the end portions 73a on the one side and the other side in the circumferential direction Dc.

According to the configuration of (1) described above, the strength of the end portions 73a of the curved surface portion 73 on the one side and the other side can be improved and thus even in a case where the longitudinal wall portion (the leading edge side retainer 61 and the trailing edge side retainer 63) is deformed due to heat from the combustion gas FG, stress in the vicinities of the end portions 73a of the curved surface portion 73 on the one side and the other side can be suppressed. Accordingly, the low-cycle fatigue strength of the vicinities of the end portions 73a of the curved surface portions 73 on the one side and the other side is improved, and the durability of the turbine stator vane 21 is improved.

(2) In some embodiments, in the configuration of (1) described above, the curved surface portion 73 may include the non-thick portion 76 that is positioned between the thick portions 75 at the end portions 73a on the one side and the other side in the circumferential direction Dc and of which the thickness is smaller than the thickness of the thick portions 75.

According to the configuration of (2) described above, the vicinities of the end portions 73a of the curved surface portion 73 on the one side and the other side, of which the strength needs to be improved, can be efficiently reinforced.

(3) In some embodiments, in the configuration of (2) described above, the thick portions 75 may be formed on a surface of a plate portion constituting the curved surface portion 73 through padding.

According to the configuration of (3) described above, the vicinities of the end portions 73a of the curved surface portion 73 on the one side and the other side, of which the strength needs to be improved, can be reinforced relatively easily.

(4) In some embodiments, in the configuration of any one of (1) to (3) described above, the curved surface 253a of the connecting portion 253 may connect the end surfaces 251a of the pair of circumferential wall portions 251 on the opposite side and the surfaces 61b and 63b of the longitudinal wall portion (the leading edge side retainer 61 and the trailing edge side retainer 63) to each other. At least the end portions 73a of the curved surface portion 73 of the first plate member 70 may be welded to the curved surface 253a of the connecting portion 253, the end portions 73a being end portions on the one side and the other side in the circumferential direction Dc.

According to the configuration of (4) described above, the first plate member 70 is welded and fixed to the curved surface 253a of the connecting portion 253 in the vicinities of the thick portions 75.

(5) In some embodiments, in the configuration of (4) described above, the first planar portion 71 of the first plate member 70 may be welded to the end surfaces 251a of the pair of circumferential wall portions 251 on the opposite side and the second planar portion 72 of the first plate member 70 may be welded to the surfaces 61b and 63b of the longitudinal wall portion (the leading edge side retainer 61 and the trailing edge side retainer 63). The weld leg length Ls3 of the welded portions 93 between the end portions 73a of the curved surface portion 73 on the one side and the other side in the circumferential direction Dc and the curved surface 253a of the connecting portion 253 may be larger than the weld leg length Ls1 of the welded portions 91 between the first planar portion 71 and the end surfaces 251a of the pair of circumferential wall portions 251 on the opposite side and the weld leg length Ls2 of the welded portions 92 between the second planar portion 72 and the surfaces 61b and 63b of the longitudinal wall portion (the leading edge side retainer 61 and the trailing edge side retainer 63).

According to the configuration of (5) described above, stress can be suppressed at the welded portions 93 between the end portions 73a of the curved surface portion 73 on the one side and the other side in the circumferential direction Dc and the curved surface 253a of the connecting portion 253, which are welded portions at which stress is likely to become relatively large due to deformation of the longitudinal wall portion (the leading edge side retainer 61 and the trailing edge side retainer 63) caused by heat from the combustion gas FG.

(6) In some embodiments, in the configuration of any one of (1) to (5) described above, the second plate member 80 that partitions the cavity 69 into the region 69o on an outer side in the vane height direction h and the region 69i on an inner side in the vane height direction h may be provided.

According to the configuration of (6) described above, the cavity 69 may be partitioned into the region 69o on the outer side in the vane height direction h and the region 69i on the inner side in the vane height direction h by the second plate member 80.

(7) In some embodiments, in the configuration of (6) described above, the second plate member 80 may be welded to surfaces (the inner surfaces 251i) of the pair of circumferential wall portions 251 that face each other in the circumferential direction Dc.

According to the configuration of (7) described above, the amount of molten metal at the welded portions 91 at the time of fillet welding of the first plate member 70 and the end surfaces 251a of the pair of circumferential wall portions 251 can be reduced and thus welding distortion of the welded portions 91 can be suppressed.

(8) The gas turbine 10 according to at least one embodiment of the present disclosure includes the turbine stator vane 21 having a configuration according to any one of (1) to (7) described above.

According to the configuration of (8) described above, the durability of the turbine stator vane 21 is improved and thus the reliability of the gas turbine 10 is improved.

### REFERENCE SIGNS LIST

10: gas turbine
21: turbine stator vane (stator vane)
23: stator vane body (airfoil portion)
25: inner shroud
25a: gas path surface
25b: surface
25c: end portion
61: leading edge side retainer
61a: end portion
61b: surface
63: trailing edge side retainer
63a: end portion
63b: surface
67: recessed portion
69: cavity
69i: region on inner side
69o: region on outer side
70: first plate member
71: first planar portion
72: second planar portion
73: curved surface portion
73a: end portion
75: thick portion
75a: end portion
76: non-thick portion
80: second plate member
91, 92, 93, 94: welded portion
251: circumferential wall portion
251a: end surface
253: connecting portion
253a: curved surface

1. A turbine stator vane comprising:
an airfoil portion;
an inner shroud that is provided inside the airfoil portion in a vane height direction;
a pair of circumferential wall portions that extends, at end portions of the inner shroud on one side and the other side in a circumferential direction, along a direction in which the end portions extend and that protrudes from the inner shroud toward an opposite side to the airfoil portion in the vane height direction;
a longitudinal wall portion that extends in the circumferential direction such that end portions on the one side and the other side in the circumferential direction are connected to the pair of circumferential wall portions, that protrudes from the inner shroud toward the opposite side to the airfoil portion in the vane height direction, and that protrudes to be closer to the opposite side in the vane height direction than the pair of circumferential wall portions is;
a connecting portion that connects the pair of circumferential wall portions and the longitudinal wall portion to each other via a gently curved surface; and
a first plate member that forms a cavity together with a surface of the inner shroud on the opposite side and the pair of circumferential wall portions,
wherein the first plate member includes a first planar portion extending along the pair of circumferential wall portions, a second planar portion extending along the longitudinal wall portion, and a curved surface portion extending along the connecting portion, and
the curved surface portion includes thick portions of which a thickness is larger than thicknesses of the first planar portion and the second planar portion, the thick portions being provided at at least end portions on the one side and the other side in the circumferential direction.

2. The turbine stator vane according to claim 1,
wherein the curved surface portion includes a non-thick portion that is positioned between the thick portions at the end portions on the one side and the other side in the circumferential direction and of which a thickness is smaller than the thickness of the thick portions.

3. The turbine stator vane according to claim 2,
wherein the thick portions are formed on a surface of a plate portion constituting the curved surface portion through padding.

4. The turbine stator vane according to claim 1,
wherein the curved surface of the connecting portion connects end surfaces of the pair of circumferential wall portions on the opposite side and a surface of the longitudinal wall portion to each other, and
at least end portions of the curved surface portion of the first plate member are welded to the curved surface of the connecting portion, the end portions being end portions on the one side and the other side in the circumferential direction.

5. The turbine stator vane according to claim 4,
wherein the first planar portion of the first plate member is welded to the end surfaces of the pair of circumferential wall portions on the opposite side and the second planar portion of the first plate member is welded to the surface of the longitudinal wall portion, and
a weld leg length of welded portions between the end portions of the curved surface portion on the one side and the other side in the circumferential direction and the curved surface of the connecting portion is larger than a weld leg length of welded portions between the first planar portion and the end surfaces of the pair of circumferential wall portions on the opposite side and a weld leg length of a welded portion between the second planar portion and the surface of the longitudinal wall portion.

6. The turbine stator vane according to claim 1, further comprising:
a second plate member that partitions a cavity into a region on an outer side in the vane height direction and a region on an inner side in the vane height direction.

7. The turbine stator vane according to claim 6,
wherein the second plate member is welded to surfaces of the pair of circumferential wall portions that face each other in the circumferential direction.

8. A gas turbine comprising:
the turbine stator vane according to claim 1.
